(19) United States
(12) Patent Application Publication
(10) Pub. No.: US 2002/0150123 A1
(43) Pub. Date: Oct. 17, 2002

(54) System and method for network delivery of low bit rate multimedia content

(75) Inventor: Sookwang Ro, Los Angeles, CA (US)

Correspondence Address: KING & SPALDING, 191 PEACHTREE STREET, N.E., ATLANTA, GA, 30303-1763, US

(73) Assignee: Cyber Operations, LLC, Jupiter, FL

(21) Appl. No.: 10/119,878

(22) Filed: Apr. 10, 2002

Related U.S. Application Data
(60) Provisional application No. 60/283,036, filed on Apr. 11, 2001.

(51) Int. Cl. H04J 3/16; H04J 3/06

(52) U.S. Cl. 370/465; 370/509

(57) ABSTRACT

A method for transmitting low bit rate multimedia content can include separately encoding corresponding audio and video packets that represent the multimedia content and generating a system media stream comprising the corresponding audio and video packets. A network communication rate indicating a bandwidth available for transmitting the system media stream can be compared to a media transmission rate indicating a bandwidth needed to transmit the system media stream. The media transmission rate can be adjusted upon on a determination that the media transmission rate is greater than the network communication rate. The system media stream then can be decoded and presented at a remote location.

This application claims the benefit of priority to U.S. Provisional Patent Application Serial No. 60/283,036, entitled “Optimized Low Bit Rate Multimedia Content Network Delivery System,” filed Apr. 11, 2001. This application is related to U.S. Non-Provisional Patent Application of Lindsey, entitled “System and Method for Preconditioning Analog Video Signals,” filed Apr. 10, 2002, and identified by Attorney Docket No. 08475.105006. The complete disclosure of each of the above-identified priority and related applications is fully incorporated herein by reference.

### FIELD OF THE INVENTION

The present invention relates generally to delivering multimedia content over a communication network. More particularly, the present invention relates to compressing, decompressing, and transmitting non-uniform, low bit rate, multimedia content over a communication network.

### BACKGROUND OF THE INVENTION

In today's computing environment, users desire to transmit streaming multimedia content over communication networks for viewing at a remote location.

The communication networks can include a local area network, the Internet, or any internet protocol (IP) based communication network. Streaming is the process of playing sound and video (multimedia content) in real-time as it is downloaded over the network, as opposed to storing it in a local file first. Software on a computer system decompresses and plays the multimedia data as it is transferred to the computer system over the network. Streaming multimedia content avoids the delay entailed in downloading an entire file before playing the content.

To transmit the streaming multimedia content, a computer system can convert analog audio and video inputs to digital signals. Then, the computer system can encode (compress) the digital signals into a multimedia form that can be transmitted over the communication network. For example, such multimedia forms include Moving Picture Experts Group (MPEG) 1, MPEG-2, MPEG-4, MPEG-5, MPEG-7, Audio Video Interleaved (AVI), Windows Wave (WAV), and Musical Instrument Digital Interface (MIDI). The multimedia content can be transmitted over the network to a remote location. The remote location can decode (decompress) the multimedia content and present it to the viewer.

Streaming multimedia content is difficult to accomplish in real time. Typically, quality streaming requires a fast network connection and a computer powerful enough to execute the decompression algorithm in real time. However, many communication networks support only low bit rate transmission of data. Such low bit rate environments can transmit data at rates of less than 1.54 megabits per second (mbps). Additionally, most networks cannot achieve their fill bandwidth potential. Even with connection speeds from 56 kilobits per second (kbps) to several megabits per second, the amount of actual data transmitted for any specific connection can vary widely depending on network conditions. Typically, only about fifty percent of the maximum connection speed can be achieved on a network, further contributing to the low bit rate environment. Low bit rate Internet transmission typically cannot produce sufficient streaming data to allow continuous streaming of multimedia content. Accordingly, those low bit rate environments typically cannot produce quality multimedia streaming over a network.

Furthermore, the non-homogeneous environment of typical networks does not support a large volume of constant, low bit rate, real-time delivery of compressed multimedia content. “Non-homogeneous” refers to the different components that connect nodes on a network. For example, different routers can connect nodes on the network and many paths exist for data to flow from one network to another. Each router can transmit data at different rates. Additionally, at any given time, some routers experience more congestion than others. Accordingly, the non-homogeneous environment does not provide a constant transmission rate as data packets travel over the network. Each packet may take a different amount of time to reach its destination, further limiting the streaming ability of low bit rate transmissions.

A conventional approach to streaming multimedia content in a low bit rate environment involves transmitting only a few frames of audio and video per second to produce the presentation. Typically, the frame rate is 1-5 frames per second. Transmitting fewer frames can decrease the amount of bandwidth required to transmit the multimedia stream over the network. However, the low frame presentation rate produces a jerky image that does not provide a pleasurable viewing experience. The low frame rate also can produce a jerky audio presentation, which can make the audio presentation difficult to understand.

Another conventional approach to streaming multimedia content in a low bit rate environment involves buffering techniques to allow for network congestion while continuing to attempt a smooth presentation of the multimedia. Buffering delays presentation by storing data while the system waits for missing data to arrive. The system presents the multimedia content only after all of the data arrives. However, buffering is cumbersome during periods of heavy network congestion or when a disconnection occurs in the network. Additionally, buffering can result in presentation delays of fifteen seconds or more as congestion and disconnections prevent packets from timely reaching their destination. Accordingly, users can encounter long delays in viewing because of the continuous buffering technique under heavy network congestion.

Thus, real-time multimedia delivery in a non-homogeneous network is difficult at low bit rates, particularly at bit rates less than 768 kbps. Additionally, low bit rate, non-homogeneous environments make it difficult to synchronize the various media streams to the presentation timing. Since network conditions are neither predictable nor forcible, multimedia content cannot be displayed in real time at low bit rates with assured levels of quality.

Accordingly, there is a need in the art for optimizing communication networks to consistently produce an acceptable quality of video and audio streaming at low bit rates. Specifically, a need exists for compensating for the shortfalls of low bit rate environments to timely present streaming multimedia content for presentation at a remote location. A need in the art also exists for timely encoding and decoding of streaming multimedia content to produce real time presentation of the content without significant buffering delays. Furthermore, a need in the art exists for streaming multimedia content at low bit rates using compression techniques such as MPEG-1 and other standards.

### SUMMARY OF THE INVENTION

The present invention can provide a system and method for low bit rate streaming of multimedia content over a network. The system and method can provide smooth motion video presentation, synchronized audio, and dynamic system adaptation to network congestion at low transmission rates. The system and method can process various forms of multimedia content, particularly MPEG-1 packets with combined system, video, and audio streams in one synchronized packet stream.

System status information for the sending and receiving systems can be inserted into a header of the synchronized packet stream. The sending and receiving systems then exchange the status information as the synchronized packet stream is transmitted over the network. Based on the status information, the sending and receiving systems can negotiate a transmission rate for the synchronized packet stream. Accordingly, the synchronized packet stream can be adjusted to compensate for the actual communication rate across the network. The sending and receiving systems also can dynamically adjust the operation of modules and buffers to optimize packet generation, transmission, and processing, based on the status information. The receiving system can intelligently monitor the incoming packet stream to timely present the packets for presentation as they are received.

These and other aspects, objects, and features of the present invention will become apparent from the following detailed description of the exemplary embodiments, read in conjunction with, and reference to, the accompanying drawings.

### BRIEF DESCRIPTION OF THE DRAWINGS

FIG. 1 is a block diagram depicting a system for network delivery of low bit rate multimedia content according to an exemplary embodiment of the present invention.

FIG. 2 is a block diagram depicting the sending architecture of the network delivery system according to an exemplary embodiment of the present invention.

FIG. 3 is a block diagram depicting the receiving architecture of the network delivery system according to an exemplary embodiment of the present invention.

FIG. 4 is a flow chart depicting a method for network delivery of low bit rate multimedia content according to an exemplary embodiment of the present invention.

FIG. 5 is a flowchart depicting an initialization method according to an exemplary embodiment of the present invention, as referred to in Step 405 of FIG. 4.

FIG. 6 is a flowchart depicting a method for initial buffer allocation according to an exemplary embodiment of the present invention, as referred to in Step 510 of FIG. 5.

FIG. 7 is a flowchart depicting a method for generating a system media stream through data multiplexing, as referred to in Step 410 of FIG. 4.

FIG. 8 is a flowchart depicting a method for generating a network media stream according to an exemplary embodiment of the present invention, as referred to in Step 420 of FIG. 4.

FIG. 9 is a flowchart depicting a method for smoothing media packets according to an exemplary embodiment of the present invention, as referred to in Step 840 of FIG. 8.

FIG. 10 is a flowchart depicting a method for generating a network media stream header according to an exemplary embodiment of the present invention, as referred to in Step 845 of FIG. 8.

FIG. 11 is a block diagram illustrating a network header 1100 created by a header generation module according to an exemplary embodiment of the present invention.

FIG. 12 is a flow chart depicting a method for reallocating buffer size according to an exemplary embodiment of the present invention, as referred to in Steps 715 of FIGS. 7 and 8.

FIG. 13 is a flowchart depicting a method for intelligent stream management according to an exemplary embodiment of the present invention, as referred to in Step 435 of FIG. 4.

FIG. 14 is a flowchart depicting a method for decoding and presenting the system media stream according to an exemplary embodiment of the present invention, as referred to in Step 445 of FIG. 4.

### DETAILED DESCRIPTION OF EXEMPLARY EMBODIMENTS

The present invention can allow smooth presentation of low bit rate, streaming multimedia content over a communication network. A system and method of the present invention can dynamically adjust processing modules and buffers based on status information of the sending and receiving networks. The sending and receiving networks can exchange the status information in a network header embedded in the multimedia stream. The sending and receiving networks also can negotiate a media transmission rate compatible with a network communication rate of the receiving system. The receiving system can intelligently monitor the incoming media stream to timely present packets as they are received for presentation to a viewer.

Although the exemplary embodiments will be generally described in the context of software modules running in a distributed computing environment, those skilled in the art will recognize that the present invention also can be implemented in conjunction with other program modules for other types of computers. In a distributed computing environment, program modules may be physically located in different local and remote memory storage devices. Execution of the program modules may occur locally in a stand-alone manner or remotely in a client/server manner. Examples of such distributed computing environments include local area networks of an office, enterprise-wide computer networks, and the global Internet.

The processes and operations performed by the computer include the manipulation of signals by a client or server and the maintenance of these signals within data structures resident in one or more of the local or remote memory storage devices. Such data structures impose a physical organization upon the collection of data stored within a memory storage device and represent specific electrical or magnetic elements. These symbolic representations are the means used by those skilled in the art of computer programming and computer construction to most effectively convey teachings and discoveries to others skilled in the art.

The present invention also includes a computer program which embodies the functions described herein and illustrated in the appended flow charts. However, it should be apparent that there could be many different ways of implementing the invention in computer programming, and the invention should not be construed as limited to any one set of computer program instructions. Further, a skilled programmer would be able to write such a computer program to implement the disclosed invention based on the flow charts and associated description in the application text, for example. Therefore, disclosure of a particular set of program code instructions is not considered necessary for an adequate understanding of how to make and use the invention. The inventive functionality of the claimed computer program will be explained in more detail in the following description in conjunction with the remaining figures illustrating the program flow.

Referring now to the drawings, in which like numerals represent like elements throughout the figures, aspects of the present invention and the preferred operating environment will be described.

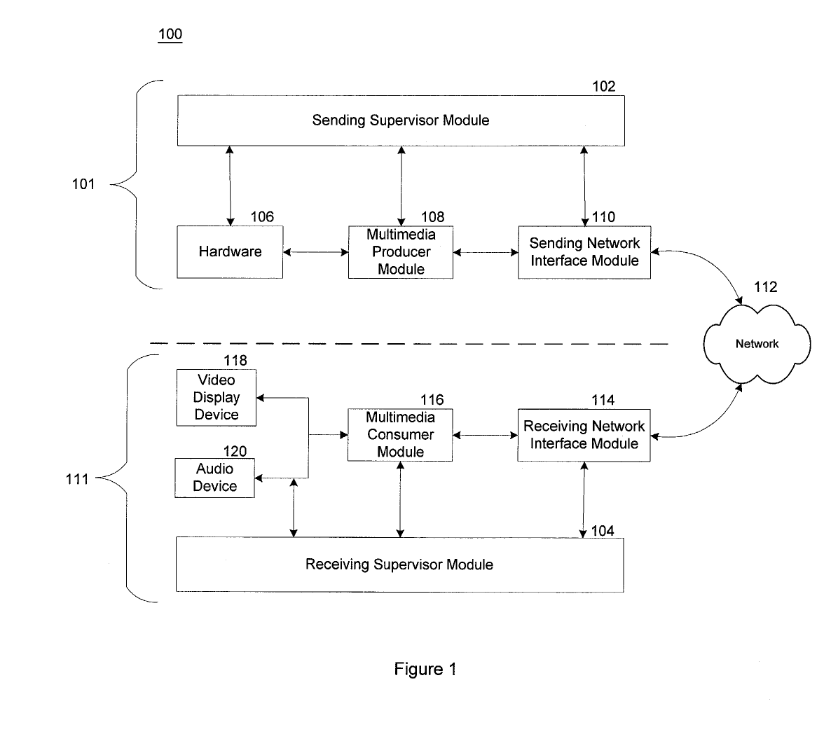

FIG. 1 is a block diagram depicting a system 100 for network delivery of low bit rate multimedia content according to an exemplary embodiment of the present invention. As shown, system 100 can include a sending architecture 101 and a receiving architecture 111. In the sending architecture 101, hardware 106 can produce analog audio and video signals that can be transmitted to a multimedia producer module 108. The hardware 106 can be coupled to the multimedia producer module by personal computer interface card inputs (not shown). The multimedia producer module 108 can convert the analog audio and video signals to digital signals. The multimedia producer module 108 also can compress those digital signals into a format for transmission to the receiving architecture 111.

After processing the analog audio and video signals, the multimedia producer module 108 can transmit the digital signals to a sending network interface module 110. The sending network interface module 110 can optimize the communication between the sending architecture 101 and the receiving architecture 111. Then, the sending network interface module 110 can transmit a data stream comprising the digital signals over a network 112 to a receiving network interface module 114 of the receiving architecture 111. For example, the network 112 can comprise the Internet, a local area network, or any internet protocol (IP) based communication network.

The receiving network interface module 114 can manage the data stream and can forward it to a multimedia consumer module 116. The multimedia consumer module 116 can decompress the digital signals in the data stream. The multimedia consumer module 116 also can convert those digital signals to analog signals for presenting video on a video display device 118 and audio on an audio device 120.

A sending supervisor module 102 of the sending architecture 101 and a receiving supervisor module 104 of the receiving architecture 111 can manage the data transmission operation. Supervisor modules 102, 104 can synchronize communications between two separate functional sites by negotiating system header codes attached to data packets in the data stream. The sending supervisor module 102 can monitor the status of the hardware 106, the multimedia producer module 108, and the sending network interface module 110. The receiving supervisor module 104 can monitor the status of the receiving network interface module 114, the multimedia consumer module 116, the video display device 118, and the audio device 120.

Each supervisor module 102, 104 can exchange the status of each module and timing information to adjust operations for optimizing the multimedia presentation. Additionally, the supervisor modules 102, 104 can exchange status information over the network 112 to optimize the communication between the sending architecture 101 and the receiving architecture 111. Accordingly, a virtual inter-process operation can be established between the sending and receiving network interface modules 110, 114 to emulate a multiprocessor environment. That emulation can allow the “sender and receiver” to function as if they are the same computer utilizing the same resources. Such a configuration can result in a virtual mirrored environment with each computer system operating in synchronization with one another.

The nature of a computing system and the network environment do not guarantee a smooth operation speed for each module in an asynchronous environment that operates in an event-based manner. However, based on the status information exchanged by supervisor modules 102, 104, buffers and transmission rates within the system 100 and synchronization timing between the individual modules can be periodically adjusted. Those periodic adjustments can increase smooth operation during a video streaming event. In an exemplary embodiment, supervisor modules 102, 104 can exchange status information about every 100 msec.

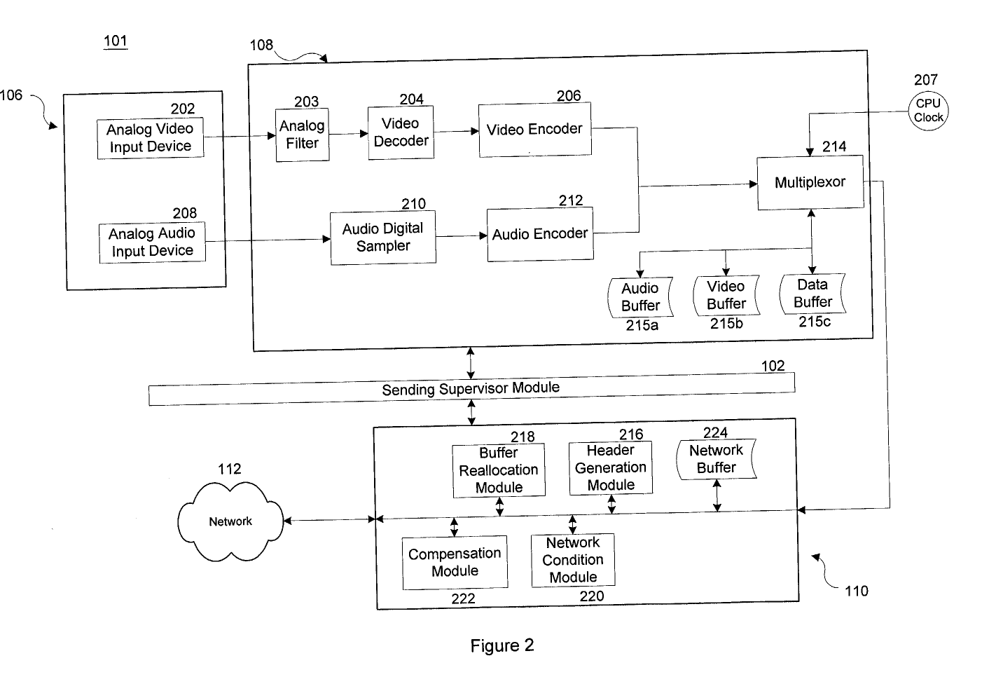

FIG. 2 is a block diagram depicting the sending architecture 101 of the network delivery system 100 according to an exemplary embodiment of the present invention. As shown, the hardware 106 can include an analog video input device 202 and an analog audio input device 208. For example, the analog video input device 202 can comprise a video cassette recorder (VCR), a digital video disk (DVD) player, or a video camera. The analog audio input device 208 can also comprise those components, as well as other components such as a microphone system. The analog video and audio input devices 202, 208 can provide analog signals to the multimedia producer module 108.

In the multimedia producer module 108, analog video signals can be transmitted to an analog filter 203. If desired, the analog filter 203 can precondition the analog video signals before those signals are amplified and converted into digital signals. The analog filter 203 can precondition the analog video signals by removing noise from those signals. The analog filter can be as described in related U.S. Non-Provisional Patent Application of Lindsey entitled “System and Method for Preconditioning Analog Video Signals,” filed Apr. 10, 2002, and identified by Attorney Docket No. 08475.105006.

The analog filter 203 can transmit the preconditioned analog video signals to a video decoder 204. The video decoder 204 can operate to convert the analog video signals into digital video signals. A typical analog video signal comprises a composite video signal formed of Y, U, and V component video signals. The Y component of the composite video signal comprises the luminance component. The U and V components of the composite video signal comprise first and second color differences of the same signal, respectively. The video decoder 204 can derive the Y, U, and V component signals from the original analog composite video signal. The video decoder 204 also can convert the analog video signals to digital video signals. Accordingly, the video decoder 204 can sample the analog video signals and can convert those signals into a digital bitmap stream. For example, the digital bitmap stream can conform to the standard International Telecommunications Union (ITU) 656 YUV 4:2:2 format (8-bit). The video decoder 204 then can transmit the digital component video signals to a video encoder 206.

The video encoder 206 can compress (encode) the digital composite signals for transmission over the network 112. The video encoder 206 can process the component signals by either a software only encoding method or by a combination hardware/software encoding method. The video encoder 206 can use various standards for compressing the video signals for transmission over a network. For example, International Standard ISO/IEC 11172-2 (video) describes the coding of moving pictures into a compressed format. That standard is more commonly known as Moving Picture Experts Group 1 (MPEG-1) and allows for the encoding of moving pictures at very high compression rates. Alternative standards include MPEG-2, 4, and 7. Other standards are not beyond the scope of the present invention. After encoding the signals, the video encoder 206 can transmit the encoded video signals in the form of a video data stream to a multiplexor 214.

The analog audio input device 208 can transmit analog audio signals to an audio digital sampler 210 of the multimedia producer module 108. The audio digital sampler 210 can convert the analog audio into a digital audio stream such as Pulse Code Modulation (PCM). Then, the audio digital sampler 210 can transmit the PCM to an audio encoder 212. The audio encoder 212 can compress the PCM into an audio stream compatible with the standard used by the video encoder 206 for the video signals. For example, the audio encoder 212 can use an MPEG-1 standard to compress the PCM into an MPEG-1 audio data stream. Alternatively, other standards can be used. The audio encoder 212 then can transmit the audio data stream to the multiplexor 214.

The multiplexor 214 receives the video and audio streams from the video encoder 206 and the audio encoder 212, respectively. The multiplexor 214 also receives a data stream associated with the compression standard used to compress the video and audio streams. For example, if the compression standard is MPEG-1, then the data stream can correspond to an MPEG-1 system stream. The multiplexor 214 can analyze each packet in the respective streams and can time stamp each packet by inserting a time in a header of the packet. The time stamp can provide synchronization information for corresponding audio and video packets. For video packets, each video frame also can be time stamped. Typically, a video frame is transmitted in more than one packet. The time stamp for the video packet that includes the beginning of a video frame also can be used as the time stamp for that video frame. The time stamps can be based on a time generated by a CPU clock 207. The time stamps can include a decoding time stamp used by a decoder in the multimedia consumer module 116 (FIG. 1) to remove packets from a buffer and a presentation time stamp used by the decoder for synchronization between the audio and video streams.

The multiplexor 214 can store time-stamped audio, video, and data packets in an audio buffer 215a, a video buffer 215b, and a data buffer 215c, respectively. The multiplexor 214 can then create a system stream by combining associated audio, video, and data packets. The multiplexer 107 can combine the different streams such that buffers in the multimedia consumer module 116 (FIG. 1) do not experience an underflow or overflow condition. Then, the multiplexor 214 can transmit the system stream to the sending network interface module 110 based on the time stamps and buffer space.

The sending network interface module 110 can store the system stream as needed in a network buffer 224. A network condition module 220 can receive network status information from the sending supervisor module 102 and the receiving supervisor module 104 (FIG. 1). The network status can comprise the network communication rate for the receiving architecture 111 (FIG. 1), a consumption rate of the receiving architecture 111, a media transmission rate of the sending architecture 101, and other status information. Architectures 101, 111 can exchange status information through network headers attached to data streams. The network headers can comprise the status information.

Based on a comparison of the network communication rate and a media transmission rate of the incoming system stream, the network condition module 220 can determine whether to adjust the system stream. If adjustments to the system stream are needed, a compensation module 222 can decrease the size of packets in the system stream or can remove certain packets from the system stream. That process can allow the network communication rate to accommodate the media transmission rate of the system stream.

A buffer reallocation module 218 can reallocate the audio, video, data, and network buffers 215a, 215b, 215c, and 224 as needed based on current system operations.

A header generation module 216 can generate a header for the system stream and can create a network data stream. Then, the sending network interface module 110 can transmit the network media stream over the network 112 to the receiving network interface module 114 (FIG. 1). The information in the network header of the network data stream can enable the network negotiations and adjustments discussed above.

The network media stream can comprise the network header and the system stream. The header generation module 216 can receive status information from the sending supervisor module 102. The header generation module 216 can include that status information in the header of the network data stream. Accordingly, the header of the network media stream can provide status information regarding the sending architecture 101 to the receiving supervisor module 104 of the receiving architecture 111.

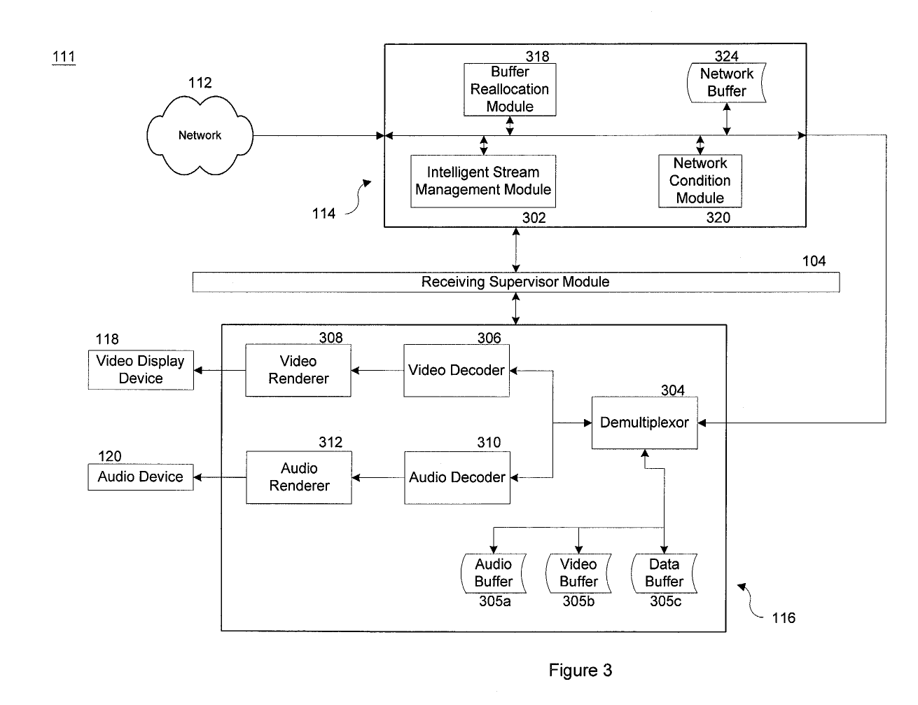

FIG. 3 is a block diagram depicting the receiving architecture 111 of the network delivery system 100 according to an exemplary embodiment of the present invention. The receiving network interface module 114 can receive the network media stream. The receiving network interface module 114 can store the network media stream as needed in a network buffer 324. The receiving network interface module 114 can consume the network packet headers to extract the network negotiation and system status information. That information can be provided to the receiving system supervisor module 104 and to a buffer reallocation module 318 for system adjustments. The receiving network interface module can also check the incoming media transmission rate and the system status of receiving architecture 111. Additionally, the receiving network interface module 114 can extract from the network header the sending architecture's 101 timing information.

An intelligent stream management module 302 can monitor each packet of the network media stream to determine the proper time to forward respective packets to the multimedia consumer module 116. A network condition module 320 can read the header information contained in the network media stream to determine the status of the components of the sending architecture 101. Additionally, the network condition module 320 can receive information regarding the status of the elements of the receiving architecture 111 from the receiving supervisor module 104. The network condition module 320 can report the status of the receiving architecture 111 over the network 112 to the sending architecture 101. The buffer reallocation module 318 can reallocate the network buffer 324 and buffers contained in the multimedia consumer module 116 as needed. The buffers can be reallocated based on the status information provided in the network header and the media transmission rate, as well as on the status of receiving architecture 111. The buffer reallocation module 318 can communicate buffer status back to the network condition module 320 and the receiving system supervisor module 104 for updating the sending architecture 101.

The receiving network interface module 114 can transmit the system media stream to the multimedia consumer module 116. In the multimedia consumer module 116, a demultiplexor 304 can receive the system media stream. The demultiplexor 304 can parse the packets of the system media stream into audio, video, and data packets. The demultiplexor 304 can store the audio, video, and data packets in an audio buffer 305a, a video buffer 305b, and a data buffer 305c, respectively. Based on the time stamps provided in the packets of the system media stream, the demultiplexor 304 can transmit the video packets and the audio packets to a video decoder 306 and an audio decoder 310, respectively.

The video decoder 306 can decode (decompress) the video packets to provide data to a video renderer 308. The video decoder 306 can use the same standard as video encoder 206 (FIG. 2) to decode the video signals. In other words, the video decoder 306 can decode the compressed video stream into decoded bitmap streams. The video renderer 308 can receive digital component video from the video decoder 306. Then, the video renderer 308 can convert the digital component video into an analog composite video signal. Based on synchronization information in the video packets, the video renderer can transmit the analog composite video signal to the video display device 118 for presentation with corresponding audio. In an exemplary embodiment, the video display device 118 can be a computer monitor.

The audio decoder 310 can receive the audio packets from the demultiplexor 304. The audio decoder 310 can decode the compressed audio stream into a decoded audio stream (PCM). Based on synchronization information in the audio packets, the audio decoder 310 can send the PCM stream to an audio renderer 312 for presentation of the audio by the audio device 120. The audio renderer 312 can be a sound card and can be included in the audio device 120.

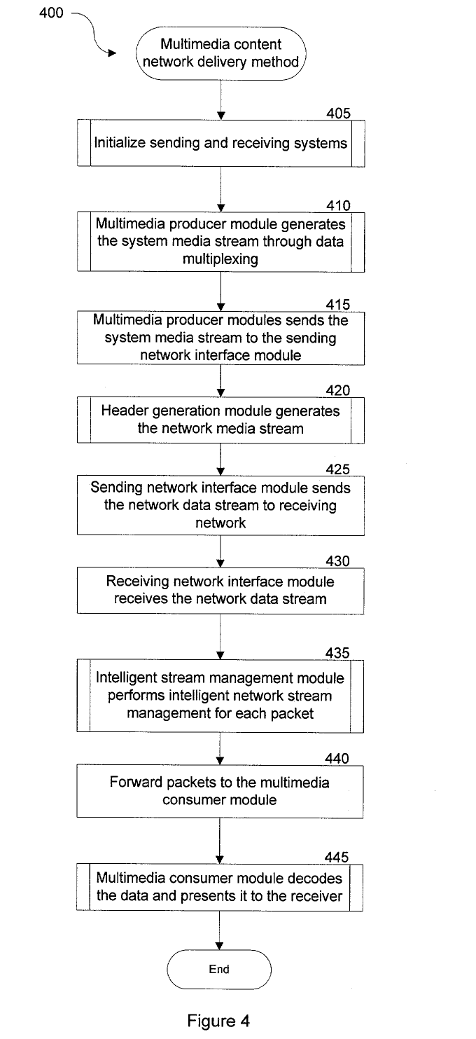

FIG. 4 is a flow chart depicting a method 400 for network delivery of low bit rate multimedia content according to an exemplary embodiment of the present invention. In Step 405, the method 400 can initialize systems within the sending architecture 101 and the receiving architecture 111. In Step 410, the multimedia producer module 108 can generate the system media steam through data multiplexing. Then in Step 415, the multimedia producer module 108 can transmit the system media stream to the sending network interface module 110. In Step 420, the header generation module can generate the network media stream, which can be transmitted in Step 425 by the sending network interface module 110 to the receiving network.

In Step 430, the receiving network interface module 114 can receive the network media stream. When the receiving network interface module 114 receives the network media stream, the network condition module 220 can read the packet headers of the system media stream to determine the system status of the sending architecture 101. In Step 435, the intelligent stream management module 302 can perform intelligent network stream management for each packet of the network media stream. At the proper time, packets from the network media stream can be transmitted in Step 440 to the multimedia consumer module 116. In Step 445, the multimedia consumer module 116 can decode the data and can present it to the receiver.

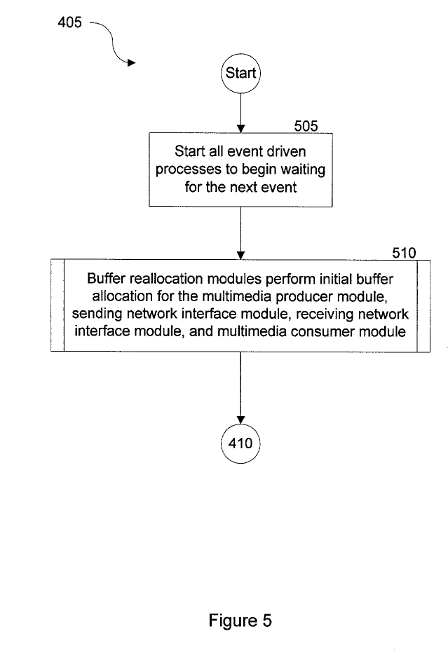

FIG. 5 is a flowchart depicting an initialization method according to an exemplary embodiment of the present invention, as referred to in Step 405 of FIG. 4. In Step 505, all event-driven processes can be started and can begin waiting for the next event. The multimedia producer and consumer modules 108, 116, the sending and receiving network interface modules 110, 114, and the sending and receiving supervisor modules 102, 104 include event-driven processes. Typically, the event is the arrival of a data packet. Accordingly, those processes can be initialized to begin waiting for the first data packet to arrive. Each of those processes can loop infinitely until it receives a termination signal. In Step 510, the buffer reallocation modules 218, 318 can perform initial buffer allocation for each of the buffers in the sending architecture 101 and the receiving architecture 111. The method then proceeds to Step 410 (FIG. 4).

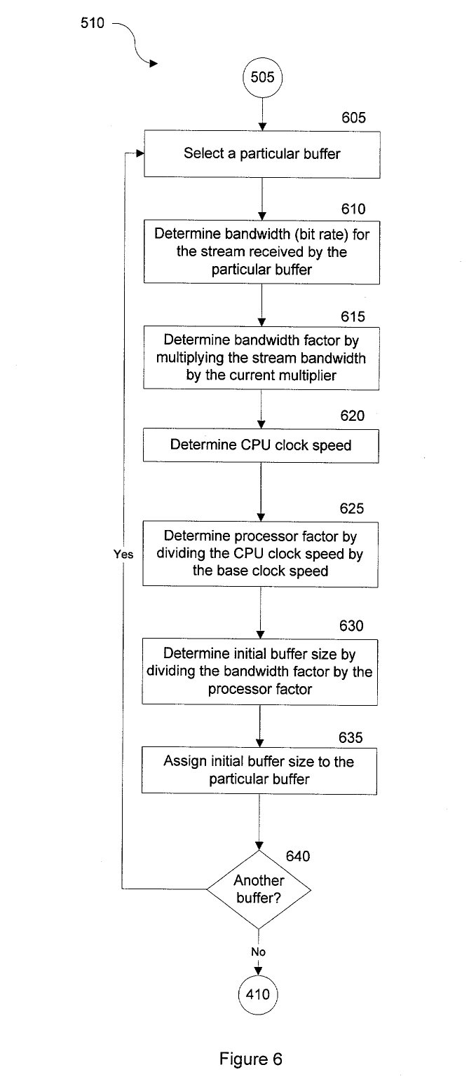

FIG. 6 is a flowchart depicting a method for initial buffer allocation according to an exemplary embodiment of the present invention, as referred to in Step 510 of FIG. 5. In the exemplary embodiment depicted in FIG. 6, buffers can be initially allocated empirically according to the bit stream rate and system processing power. In Step 605, a particular buffer to allocate can be selected from the buffers in the sending and receiving architectures 101, 111. In Step 610, the bit stream rate received by the particular buffer can be determined. For example, if the particular buffer is the audio buffer 215a, Step 610 can determine the bit stream rate of audio data received by the audio buffer 215a. Then in Step 615, a bandwidth factor can be determined by multiplying the bit stream rate by a multiplier. The multiplier can be set to optimize the system operation. In an exemplary embodiment, the multiplier can be 5.

In Step 620, the CPU clock speed can be determined for the system on which the particular buffer is located. A processor factor can be determined in Step 625 by dividing the CPU clock speed by a base clock speed. In an exemplary embodiment, the base clock speed can be 400 megahertz (MHz). Then in Step 630, the initial buffer size can be determined by dividing the bandwidth factor by the processor factor. The initial buffer size can be assigned to the particular buffer in Step 635. Then in Step 640, the method can determine whether to perform initial buffer allocation for another buffer. If yes, then the method can branch back to Step 605 to process another buffer. If initial buffer allocation will not be performed for another buffer, then the method can branch to Step 410 (FIG. 4).

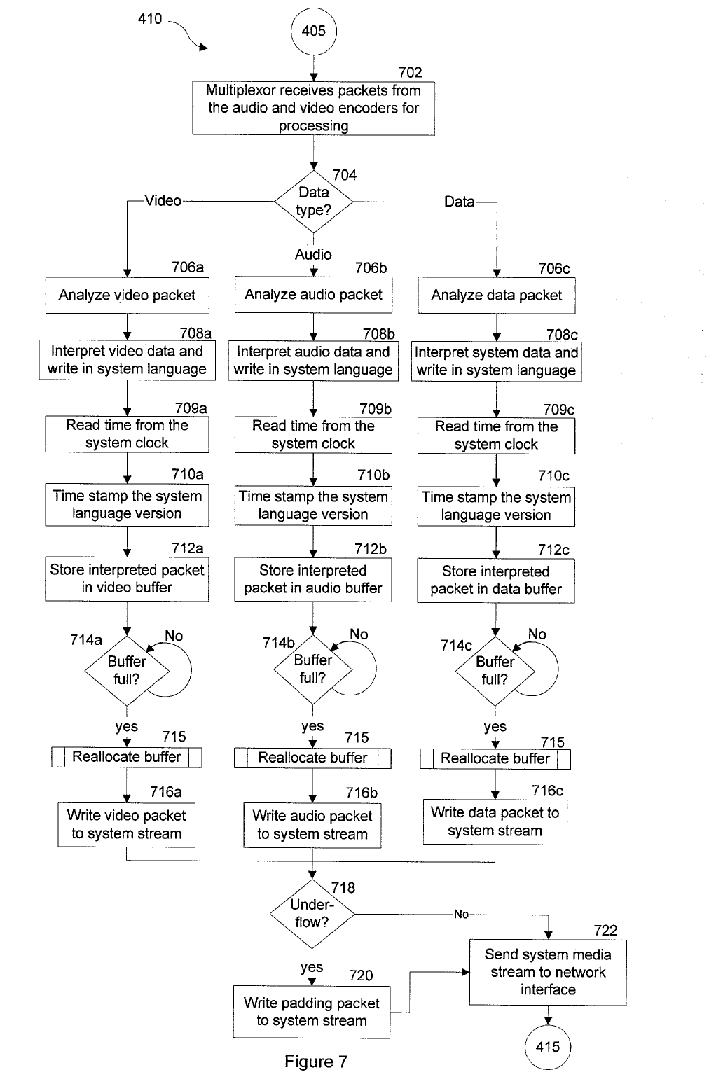

FIG. 7 is a flowchart depicting a method for generating a system media stream through data multiplexing, as referred to in Step 410 of FIG. 4. In Step 702, the multiplexor 214 can receive packets for processing from the video and audio encoders 206, 212. In Step 704, the multiplexor 214 can examine the header of a packet to determine whether the packet comprises video, audio, or data. If the method determines in Step 704 that the packet comprises video, then the method can branch to Step 706a. The multiplexor 214 can analyze the video packet in Step 706a to determine its time stamp, frame type, frame rate, and packet size. The time stamp included in the video packet can be a time stamp generated by the video decoder 204. The multiplexor 214 can interpret the video data in Step 708a and can write the video data in a system language for transmission over the network 112.

In Step 709a, the multiplexor 214 can read the current time from a system clock. In one exemplary embodiment, the multiplexor 214 can read the current time from a conventional operating system clock accessible from any computer program. Typically, such an operating system clock can provide about 20 milliseconds (msec) of precision. In an alternative exemplary embodiment, the multiplexor 214 can read the current time from a CPU clock for more precise time measurements. An exemplary embodiment can use a driver to obtain the CPU clock time. Using the CPU clock time can allow more precise control over the hardware and software of the system. For example, the CPU clock can provide a precision of less than about 20 msec and up to about 100 nanoseconds.

In step 710a, the multiplexor 214 can time stamp the clock time in a header of the system language version. The time stamp can provide synchronization information for corresponding audio and video packets. For video packets, each video frame also can be time stamped. Typically, a video frame is transmitted in more than one packet. The time stamp for the video packet that includes the beginning of a video frame also can be used as the time stamp for that video frame. The time stamp provided by the multiplexor 214 can replace the original time stamp provided by the video decoder 204. Accordingly, the precision of the timing for each packet can be increased to less than about 20 msec when the CPU clock time is used. Then in Step 712a, the multiplexor 214 can store the interpreted packet in the video buffer 215b. In Step 714a, the method can determine whether the video buffer 215b is full. If not, then Step 714a can be repeated until the buffer is full. If the method determines in Step 714a that the video buffer 215b is full, then the method can branch to Step 715. In Step 715, the size of the video buffer 215b can be reallocated as needed. Then in Step 716a, the multiplexor 214 can write the video packet to a system media stream. In Step 716a, packets can be written to the system media stream based on a mux rate setting and the time stamps.

Referring back to Step 704, if the multiplexor 214 determines that the packet comprises audio or data, then the method can perform Steps 706b-716b and Steps 706c-716c for the audio or data packets, respectively. Steps 706b-716b and Steps 706c-716c correspond to Step 706a-716a described above.

In operation, Steps 714a, 714b, and 714c can be performed simultaneously. When one of those steps determines that its corresponding video, audio, or data buffer is full, then the method can perform Step 715 and Steps 716a, 716b, and 716c simultaneously for each of the video, audio, and data packets. Accordingly, when the method determines that one of the buffers is full, video, audio, and data packets contained in the corresponding video, audio, and data buffers can be written to the system media stream.

After the video, audio, and data packets have been written to the system media stream, the method can determine if an underflow condition exists, Step 718. An underflow condition exists if the size of the system media stream is less than a pre-determined bit rate. The pre-determined bit rate can be set based on the system status monitored by the supervisor software modules 102, 104. If the supervisor modules 102, 104 detect a gap between sending and producing packets, then the predetermined bit rate can be reduced to produce variable length network packets according to network and system conditions.

If the method detects an underflow condition in Step 718, then the method can branch to Step 720. In Step 720, the multiplexor 214 can write “padding” packets to the system media stream to correct the underflow condition and to provide a constant bit rate. A padding packet can comprise data that fills the underflow condition in the system media stream. The method then proceeds to Step 722, where the multiplexor 204 can send the system media stream to the sending network interface module 110. If Step 718 does not detect an underflow condition, then the method can branch directly to Step 722. From Step 722, the method proceeds to Step 415 (FIG. 4).

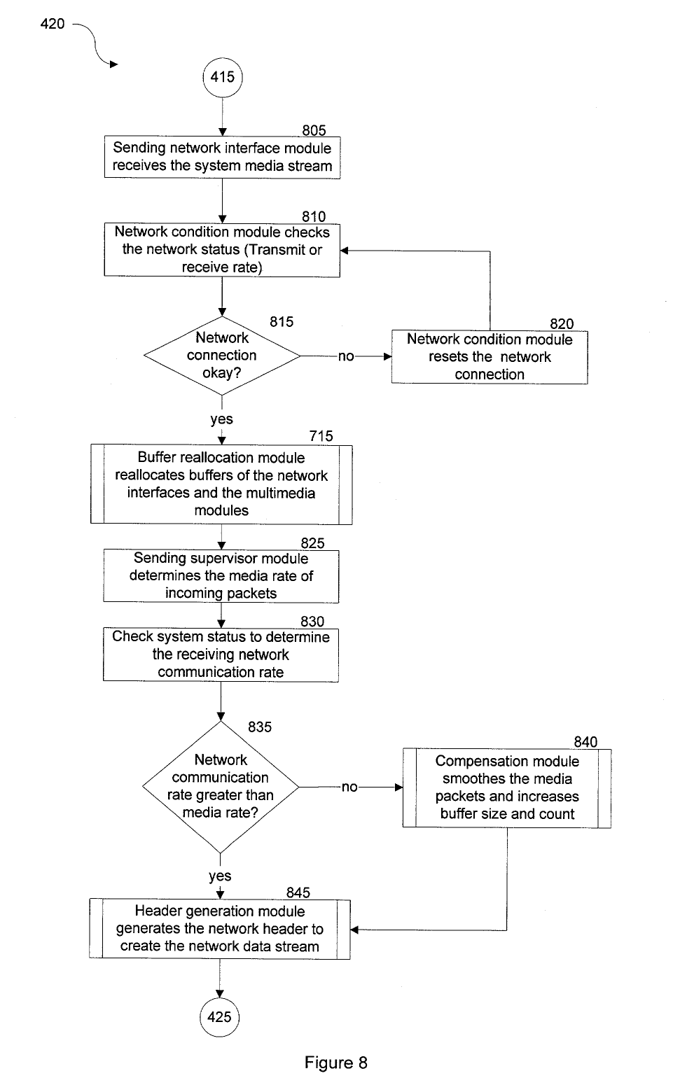

FIG. 8 is a flowchart depicting a method for generating a network media stream according to an exemplary embodiment of the present invention, as referred to in Step 420 of FIG. 4. In Step 805, the sending network interface module 110 can receive the system media stream. In Step 810, the network condition module 220 can check the network status. Network status information can include the media transmission rate of the sending architecture 101, the receive rate (communication rate) over the network 112 of the receiving architecture 111, assigned bandwidth, overhead, errors, actual transmission rates, and other information. The network status information can be provided by the supervisor modules 102, 104. Step 810 can be performed to periodically check errors, actual transmission rates, and the other items. For example, the Step 810 can be performed at a frequency from about 0.2 Hz to about 1 Hz depending on the CPU load.

In Step 815, the network condition module 220 can determine if the network connection between the sending architecture 101 and the receiving architecture 111 is satisfactory. If the network connection is not satisfactory, then the method can branch to Step 820. In Step 820, the network condition module 220 can re-set the network connection between the sending architecture 101 and the receiving architecture 111. The method then returns to Step 810. If Step 815 determines that the network connection is satisfactory, then the method can branch to Step 715. In Step 715, the buffer reallocation modules 218, 318 can reallocate buffers of the network interface modules 110, 114 and multimedia modules 108, 116 as needed, based on the system and network status information.

The method then proceeds to Step 825, where the sending supervisor module 102 can determine a media transmission rate of incoming packets to the sending network interface module 110. Then in Step 830, the sending supervisor module 102 can check the system status to determine the receiving architecture's 111 network communication rate. That information can be obtained from the receiving supervisor module 104.

Then in Step 835, the method can determine whether the receiving network's communication rate is greater than the media transmission rate of incoming packets. In other words, step 835 can determine the difference between the actual transmission rate and the desired transmission rate to negotiate compatible rates. If the receiving network's communication rate is not greater than the media transmission rate, then the method can branch to Step 840. In Step 840, the compensation module 222 can smooth the media packets to decrease the media rate. Additionally, the compensation module 222 can increase buffer size and count as needed by activating buffer reallocation modules 218, 318. The method can then proceed to Step 845, where the header generation module 216 can generate the network header to create the network media stream.

If Step 835 determines that the network communication rate is greater than the media transmission rate of incoming packets, then the method can branch directly to Step 845. From Step 845, the method can proceed to Step 425 (FIG. 4).

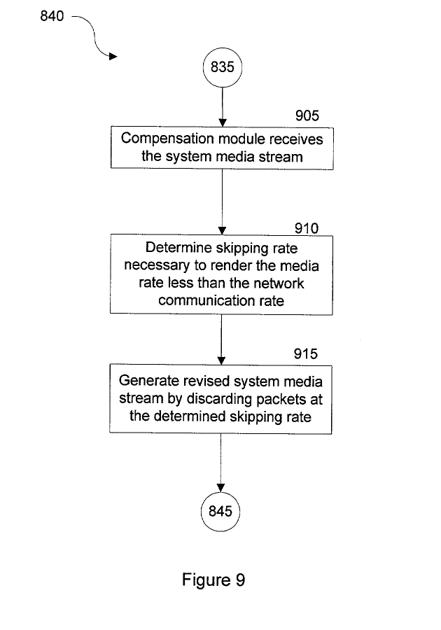

FIG. 9 is a flowchart depicting a method for smoothing media packets according to an exemplary embodiment of the present invention, as referred to in Step 840 of FIG. 8. In Step 905, the compensation module 222 can receive the system media stream. Then in Step 910, the compensation module can determine a skipping rate necessary to render the media rate less than, or equal to, the network communication rate. The method can then proceed to Step 915, where the compensation module can generate a revised system media stream by discarding packets at the determined skipping rate.

Typically, video packets includes three frame types I, B, and P for presenting a single frame of video. The I frame is coded using only information present in the picture itself with transform coding. The P frame is coded with respect to the nearest previous I or P frame with motion compensation. The B frame is coded using both a future and past frame as a reference with bidirectional prediction. Thus, the I, B, and P frames contain duplicative information. Accordingly, the compensation module 222 can skip frames containing duplicate information without affecting the final presentation of the media stream. The method can then proceed to Step 845 (FIG. 8).

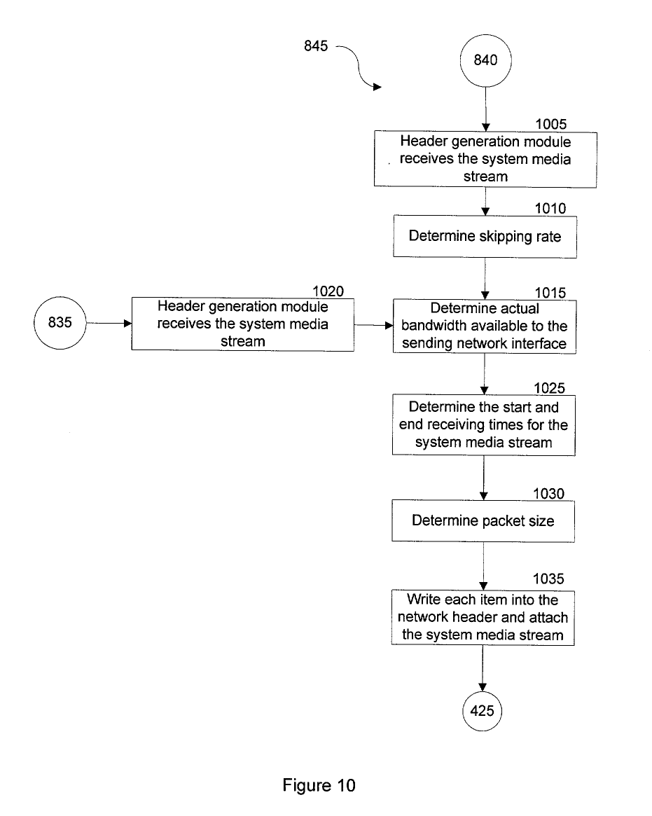

FIG. 10 is a flowchart depicting a method for generating a network media stream header according to an exemplary embodiment of the present invention, as referred to in Step 845 of FIG. 8. In Step 1005, the header generation module 216 can receive the system media stream from the compensation module 222. Then in Step 1010, the header generation module 216 can determine the skipping rate used by the compensation module 222 to smooth the media stream. The compensation module 222 can supply the skipping rate to the header generation module 216. The method can then proceed to Step 1015. Accordingly, Steps 1005 and 1010 are only performed when the compensation module 222 smoothes the media stream.

When the media stream is not smoothed, the header generation module 216 can receive the system media stream in Step 1020. The method can then proceed to Step 1015, where the header generation module 216 can determine the actual bandwidth available to the sending network interface module 114. Then in Step 1025, the header generation module 216 can determine the start and end receiving times for the system media stream. In Step 1030, the header generation module 216 can determine the packet size for the system media stream. Then in Step 1035, the header generation module 216 can write each item determined above into a network header and can attach the system media stream to generate the network media stream. The information determined in Steps 1010 and 1015-1030 can provide status information of the sending architecture 101 to the receiving architecture 111. From Step 1035, the method can proceed to Step 425 (FIG. 4).

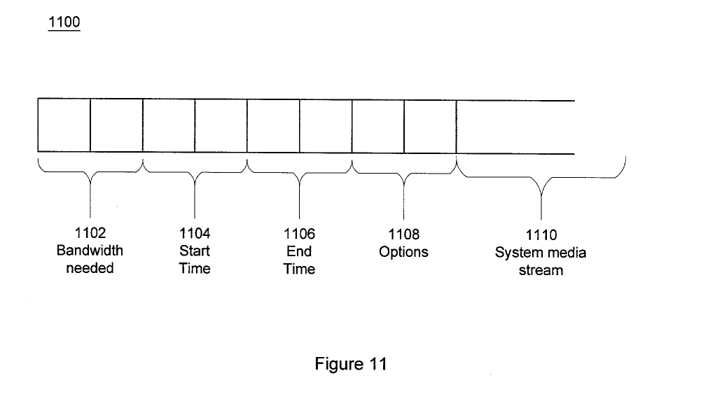

FIG. 11 is a block diagram illustrating a network header 1100 created by the header generation module 216 according to an exemplary embodiment of the present invention. The packet header format can be the same for both the sender and receiver. The network header can be imbedded into the encoded data stream. For example, the network header can be imbedded into the MPEG-1 data stream if an MPEG-1 standard is used to encode the multimedia data. The first two bytes 1102 of Header 1100 can indicate the encoded bit rate (media transmission rate). Accordingly, those two bytes 1102 can exchange information about the actual stream bit rate through the network connection 112 of the sending architecture 101 and the receiving architecture 111. The next four bytes 1104, 1106 can provide the start and end times respectively to synchronize the start and stop time for the encoding or decoding process. Those four bytes 1104, 1106 can provide the system's timing code to allow precise matching of the audio and video in the multimedia stream. The last two bytes 1108 can provide optional system status information. For example, the optional system status information can include a bit stream discontinuance start time and a time that the stream is restarted. The actual system media stream 1110 follows the network header bytes 1102-1108.

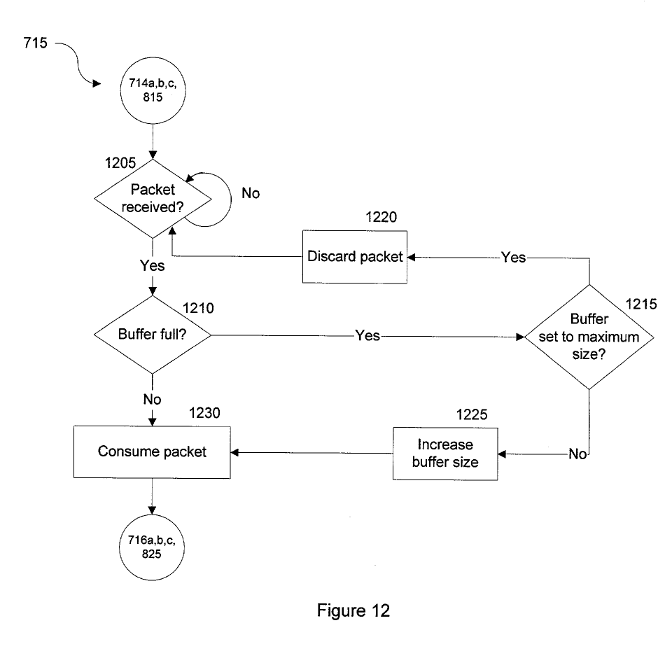

FIG. 12 is a flow chart depicting a method for reallocating buffer size according to an exemplary embodiment of the present invention, as referred to in Steps 715 of FIGS. 7 and 8. Buffer reallocation modules 218, 318 can perform the buffer reallocation method for any of the buffers contained in the sending architecture 101 and the receiving architecture 111. Accordingly, the method depicted in FIG. 12 is representative of a method performed for a particular buffer within the architectures 101, 111. In Step 1205, the buffer reallocation module 218 or 318 can determine whether the particular buffer has received a packet. If not, then the method can repeat Step 1205 until the particular buffer receives a packet. If the particular buffer has received a packet, then the method can branch to Step 1210. In Step 1210, the method can determine whether the particular buffer is full. If the particular buffer is full, then the method can branch to Step 1215.

In Step 1215, the buffer reallocation module 218 or 318 can determine whether the buffer is set to its maximum size. The maximum size can be configured based on individual system requirements. If the particular buffer is set to its maximum size, then the method can branch to Step 1220. In Step 1220, the packet can be discarded. The method can then return to Step 1205 to await a new packet.

If Step 1215 determines that the buffer is not set to its maximum size, then the method can branch to Step 1225. In Step 1225, the buffer reallocation module 218, 318 can increase the buffer size of the particular buffer. The method can then proceed to Step 1230, where the packet can be consumed. The packet can be consumed in different manners based on the particular buffer or associated module. For example, the particular buffer can consume the packet by storing the packet in its memory. Alternatively, the multiplexor 214 can consume the packet by writing it to the system media stream. The sending network interface module 110 can consume the packet by sending it to the compensation module 222, the header generation module 216, the network buffer 224, or over the network 112 to the receiving network interface module 114. Similarly, the receiving network interface module 114 can consume the packet by sending the packet to the network buffer 324, the intelligent stream management module 302, or the demultiplexor 304.

Referring back to Step 1210, if the method determines that the particular buffer is not full, then the method can branch directly to Step 1230. From Step 1230, the method can branch back to one of Steps 716a, 716b, 716c, or 825 (FIG. 7 or 8).

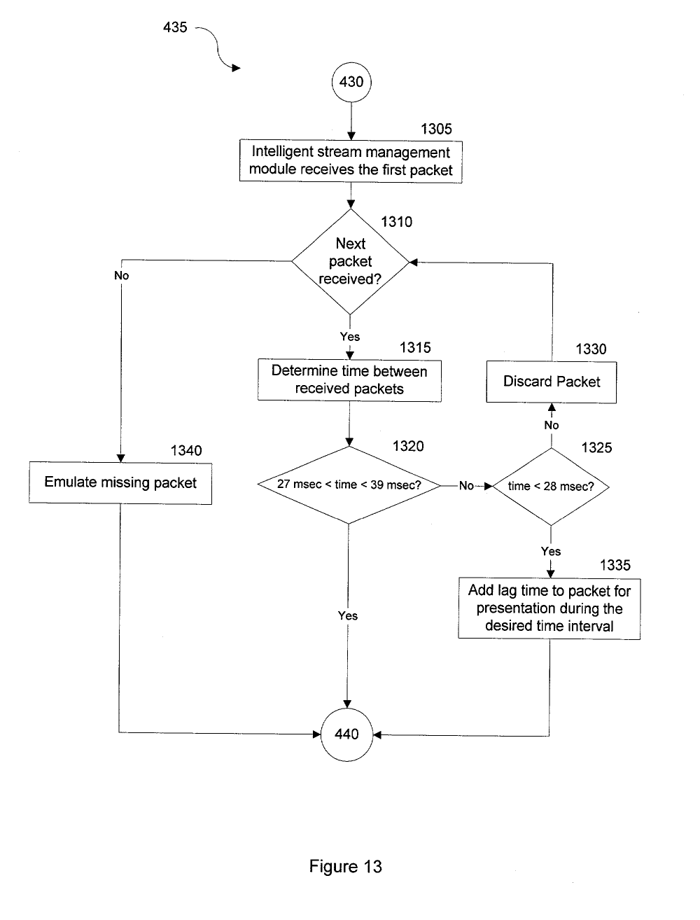

FIG. 13 is a flowchart depicting a method for intelligent stream management according to an exemplary embodiment of the present invention, as referred to in Step 435 of FIG. 4. The method illustrated in FIG. 13 can accommodate continuous video streaming without the need for long periods of buffering. For example, the method illustrated in FIG. 13 can allow continuous, timely presentation of video packets while only buffering about 300 msec of data. Basically, the video packets can be presented as soon as they are received with only micro timing adjustments.

In Step 1305, the intelligent stream management module 302 can receive the first packet of the system stream. Then in Step 1310, the intelligent stream management module 302 can determine whether it has received the next video packet of the system stream. If yes, then the method can branch to Step 1315.

In Step 1315, the intelligent stream management module can determine a time interval between the received packets. In Step 1320, the intelligent stream management module can determine whether the receiving network interface module 114 received the packets at a predetermined rate. In an exemplary embodiment, the predetermined rate can correspond to a frame presentation rate of about 33 msec (10 frames per second). Alternatively, as shown in the exemplary embodiment of FIG. 13, the predetermined rate can be a range of about 27 msec to about 39 msec.

Accordingly, Step 1320 can determine whether the time interval between the packets is in the range of about 27 msec to about 39 msec. If not, then the method can branch to Step 1325. In Step 1325, the method can determine whether the time between the received packets is less than about 28 msec. If not, then the method can branch to Step 1330. If Step 1330 is performed, then the method has determined that the time interval between the packets was greater than about 39 msec. Accordingly, it may be too late to present the last received packet, and Step 1330 can discard the late packet. The method can then proceed back to Step 1310 to await the next received packet.

If Step 1325 determines that the time between the received packet is less than about 28 msec, then the method can branch to Step 1335. In Step 1335, the intelligent stream management module 302 can add a lag time to the packet to allow presentation during the desired time interval. For example, the intelligent stream management module can add a lag time to the packet to allow presentation of one frame about every 33 msec. The lag time can be added to the synchronization information in the header of the packet. The method can then proceed to Step 440 (FIG. 4).

Referring back to step 1320, if the time interval between the packets is within the predetermined rate, then the method can branch directly to Step 440 (FIG. 4). Alternatively, micro adjustments can be made to the packet even if its time interval is within the predetermined rate. For example, a lag time of 1-5 msec can be added to packets received in a time interval of 28-32 msec to allow presentation at a frame rate of 33 msec.

Accordingly, an exemplary embodiment can allow communications between computer systems to contain small timing differences between video frames. The receiving architecture 111 can adjust its presentation timing to allow presentation of each video frame within the predetermined rate. Thus, long buffering periods to synchronize the packets can be avoided, and the packets can be presented as they are received with micro timing adjustments. In the exemplary embodiment shown in FIG. 13, the video frames can be presented within 1 to 4 msec of a target rate of one frame per 33 msec. That short duration of timing differential is not detectable by humans in the normal viewing of multimedia. Human perception of temporal distortion is limited to about 33 msec at 30 frames per second.

Referring back to Step 1310, if the method determines that the next packet was not received in less than about 39 msec, then the method can branch to Step 1340. In Step 1340, the intelligent stream management module 302 can emulate the missing packet. Emulating the missing packet can simulate a constant frame rate to allow better synchronization of the audio and video. The missing packet can be emulated by duplicating frames from a previous packet or a later received packet. Alternatively, the missing packet can be emulated by estimating the missing data based on frames from the previous packet or a later received packet. Step 1340 can be performed when a packet is not received and when a packet is late. A late packet will also be discarded in step 1330. From Step 1340, the method proceeds to Step 440 (FIG. 4).

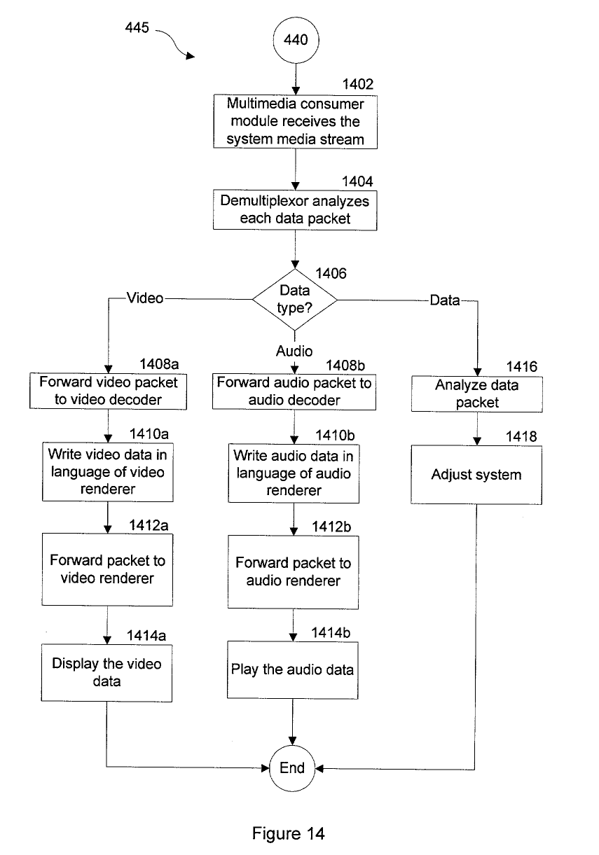

FIG. 14 is a flowchart depicting a method for decoding and presenting the system media stream according to an exemplary embodiment of the present invention, as referred to in Step 445 of FIG. 4. In Step 1402, the multimedia consumer module 116 can receive the system media stream from the receiving network interface module 114. Then in Step 1404, the demultiplexor 304 can analyze the header of each packet. The demultiplexor 304 can store packets in buffers 305a, 305b, 305c as needed. In Step 1406, the demultiplexor 304 can determine whether the packet comprises video, audio, or data. If the packet comprises video, then the method can branch to Step 1408a, where the video packet can be forwarded to the video decoder 306. Then in Step 1410a, the video decoder 306 can decode the compressed video stream into bitmap streams, which can be written in the language of a particular video renderer. In Step 1412a, the video decoder 306 can forward a bitmap packet to the video renderer 308. The video renderer 308 then displays the video data on an analog display device in Step 1414a.

Referring back to Step 1406, if the demultiplexor 304 determines that the packet comprises audio data, then Steps 1408b-1414b can be performed for the audio packet. Steps 1408b-1414b correspond to Steps 1408a-1414a discussed above for the video packet.

Referring back to Step 1406, if the demultiplexor 304 determines that the packet comprises data only, then the method can branch to Step 1416. In Step 1416, the demultiplexor 304 can analyze the data packet. Information from the data packet can be used in Step 1418 to adjust the system for proper presentation of the audio and video components.

The present invention can be used with computer hardware and software that performs the methods and processing functions described above. As will be appreciated by those skilled in the art, the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

Although specific embodiments of the present invention have been described above in detail, the description can be merely for purposes of illustration. Various modifications of, and equivalent steps corresponding to, the disclosed aspects of the exemplary embodiments, in addition to those described above, can be made by those skilled in the art without departing from the spirit and scope of the present invention defined in the following claims, the scope of which is to be accorded the broadest interpretation so as to encompass such modifications and equivalent structures.

What is claimed is:

1. A computer-implemented method for communicating low bit rate multimedia content, said method comprising the steps of:
encoding corresponding audio and video packets that represent the multimedia content;
time stamping a header of each of the corresponding audio and video packets with a time providing synchronization information for the corresponding audio and video packets;
generating a system media stream comprising the corresponding audio and video packets;
negotiating a communication rate for communicating the system media stream;
decoding the corresponding audio and video packets of the system media stream; and
presenting the multimedia content represented by the decoded audio and video packets based on the synchronization information provided in the headers of the audio and video packets.

2. The method according to claim 1, wherein the time used in said time stamping step comprises a time generated by a precision clock that is precise to less than 1 microsecond.

3. The method according to claim 1, wherein said encoding step comprises encoding the corresponding audio and video packets using an MPEG-1 compression standard.

4. The method according to claim 1, wherein said negotiating step comprises the steps of:
determining a network communication rate indicating a bandwidth available for communicating the system media stream;
determining a media transmission rate indicating a bandwidth used to communicate the system media stream;
determining whether the media transmission rate is greater than the network communication rate; and
adjusting the media transmission rate upon on a determination that the media transmission rate is greater than the network communication rate.

5. The method according to claim 4, wherein said adjusting step comprises reducing a size of the corresponding audio and video packets in the system media stream to reduce the media transmission rate.

6. The method according to claim 4, wherein said adjusting step comprises smoothing video packets in the system media stream to reduce the media transmission rate to at least the network communication rate.

7. The method according to claim 6, wherein said smoothing step comprises the steps of:
determining a skipping rate necessary to render the media transmission rate less than the network communication rate; and
generating a revised system media stream by discarding video frames within the video packets at the determined skipping rate.

8. The method according to claim 7, further comprising the step of generating a network header comprising the skipping rate for the system media stream,
wherein said presenting step further comprises presenting the multimedia content based on the skipping rate provided in the network header.

9. The method according to claim 4, further comprising the step of generating a network header comprising the media transmission rate for the system media stream,
wherein said step of determining the media transmission rate comprises reading the network header.

10. The method according to claim 1, further comprising the step of intelligently managing the system media stream to timely present the multimedia content in said presenting step.

11. The method according to claim 10, wherein said managing step comprises the steps of:
determining a time interval between a first video packet and a second video packet in the system media stream to determine whether the first and second video packets are received at a predetermined rate; and
adding a lag time to the synchronization information of the second video packet upon a determination that the time interval is less than the predetermined rate,
wherein a sum of the lag time and the time interval equals the predetermined rate.

12. The method according to claim 11, wherein the predetermined rate comprises a range of about 27 msec to about 39 msec.

13. The method according to claim 11, wherein the predetermined rate comprises about 33 msec.

14. The method according to claim 11, further comprising the step of discarding the second video packet upon a determination that the time interval is greater than the predetermined rate.

15. The method according to claim 10, wherein said managing step comprises the steps of:
receiving a first video packet of the system media stream;
determining whether a second video packet is received within a specified time after receiving the first video packet, the specified time corresponding to a predetermined rate for receiving packets; and
emulating the second video packet upon a determination that the second video packet was not received within the specified time.

16. The method according to claim 15, wherein said emulating step comprises duplicating the first video packet.

17. The method according to claim 15, wherein said emulating step comprises estimating the second video packet based on the first video packet.

18. The method according to claim 15, wherein the specified time is about 39 msec.

19. A computer-readable medium having computer-executable instructions for performing the steps recited in claim 1.

20. A computer-implemented method for transmitting low bit rate multimedia content, said method comprising the steps of:
encoding corresponding audio and video packets that represent the multimedia content, the audio and video packets comprising synchronization information for the corresponding audio and video packets;
generating a system media stream comprising the corresponding audio and video packets;
determining a network communication rate indicating a bandwidth available for transmitting the system media stream;
determining a media transmission rate indicating a bandwidth used to transmit the system media stream;
determining whether the media transmission rate is greater than the network communication rate; and
adjusting the media transmission rate upon on a determination that the media transmission rate is greater than the network communication rate.

21. The method according to claim 20, further comprising the steps of:
decoding the corresponding audio and video packets of the system media stream; and
presenting the multimedia content represented by the decoded audio and video packets based on the synchronization information provided in the headers of the audio and video packets.

22. The method according to claim 20, wherein said adjusting step comprises reducing a size of one of the corresponding audio and video packets in the system media stream to reduce the media transmission rate.

23. The method according to claim 20, wherein said adjusting step comprises smoothing video packets in the system media stream to reduce the media transmission rate to at least the network communication rate.

24. The method according to claim 23, wherein said smoothing step comprises the steps of:
determining a skipping rate necessary to render the media transmission rate less than the network communication rate; and
generating a revised system media stream by discarding video frames within the video packets at the determined skipping rate.

25. The method according to claim 24, further comprising the steps of:
generating a network header comprising the skipping rate for the system media stream;
decoding the corresponding audio and video packets of the system media stream; and
presenting the multimedia content represented by the decoded audio and video packets based on the synchronization information provided in the headers of the audio and video packets and on the skipping rate provided in the network header.

26. The method according to claim 20, further comprising the step of generating a network header comprising the media transmission rate for the system media stream,
wherein said step of determining the media transmission rate comprises reading the network header.

27. A computer-readable medium having computer-executable instructions for performing the steps recited in claim 20.

28. A computer-implemented method for receiving low bit rate multimedia content in a system media stream, the system media stream comprising encoded audio and video packets representing the multimedia content, and each audio and video packet comprising synchronization information for synchronizing corresponding audio and video packets, said method comprising the steps of:
determining a time interval between a first video packet and a second video packet in the system media stream to determine whether the first and second video packets are received at a predetermined rate;
adding a lag time to the synchronization information of the second video packet upon a determination that the time interval is less than the predetermined rate, wherein a sum of the lag time and the time interval equals about the predetermined rate;
decoding the first and second video packets and their corresponding audio packets; and
presenting the multimedia content represented by the decoded packets based on the synchronization information provided in the headers of the first and second video packets and their corresponding audio packets.

29. The method according to claim 28, wherein the predetermined rate comprises a range of about 27 msec to about 39 msec.

30. The method according to claim 28, wherein the predetermined rate comprises about 33 msec.

31. The method according to claim 28, further comprising the step of discarding the second video packet upon a determination that the time interval is greater than the predetermined rate.

32. A computer-readable medium having computer-executable instructions for performing the steps recited in claim 28.

33. A computer-implemented method for receiving low bit rate multimedia content in a system media stream, the system media stream comprising encoded audio and video packets representing the multimedia content, and each audio and video packet comprising synchronization information for synchronizing corresponding audio and video packets, said method comprising the steps of:
receiving a first video packet of the system media stream;
determining whether a second video packet of the system media stream is received within a specified time after receiving the first video packet, the specified time corresponding to a predetermined rate for receiving packets;
emulating the second video packet upon a determination that the second video packet was not received within the specified time, the emulated video packet comprising synchronization information for synchronizing the emulated video packet to the audio packet corresponding to the second video packet;
decoding the first video packet, the emulated video packet, and corresponding audio packets; and
presenting the multimedia content represented by the decoded packets based on the synchronization information provided in the headers of the first video packet, the emulated video packet, and the corresponding audio packets.

34. The method according to claim 33, wherein said emulating step comprises duplicating the first video packet.

35. The method according to claim 33, wherein said emulating step comprises estimating the second video packet based on the first video packet.

36. The method according to claim 33, wherein the specified time is about 39 msec.

37. A computer-readable medium having computer-executable instructions for performing the steps recited in claim 33.

38. A system for receiving low bit rate multimedia content in a system media stream, the system media stream comprising encoded audio and video packets representing the multimedia content, and each audio and video packet comprising synchronization information for synchronizing corresponding audio and video packets, said system comprising:
a demultiplexor operable to receive the system media stream and to transmit the video and audio packets for presentation based on the synchronization information; and
an intelligent stream management module operable to intelligently manage the system media stream to timely transmit the video and audio packets to said demultiplexor by:
receiving a first video packet and a second video packet in the system media stream;
determining a time interval between the first video packet and the second video packet to determine whether the first and second video packets are received at a predetermined rate;
adding a lag time to the synchronization information of the second video packet upon a determination that the time interval is less than the predetermined rate, wherein a sum of the lag time and the time interval equals about the predetermined rate; and
transmitting the first and second video packets to said demultiplexor based on the synchronization information for the first and second video packets and their corresponding audio packets.

39. The system according to claim 38, wherein the predetermined rate comprises a range of about 27 msec to about 39 msec.

40. The system according to claim 38, wherein the predetermined rate comprises about 33 msec.

41. The system according to claim 38, wherein said intelligent stream management module is further operable to perform the step of discarding the second video packet upon a determination that the time interval is greater than the predetermined rate.

42. A system for receiving low bit rate multimedia content in a system media stream, the system media stream comprising encoded audio and video packets representing the multimedia content, and each audio and video packet comprising synchronization information for synchronizing corresponding audio and video packets, said system comprising:
a demultiplexor operable to receive the system media stream and to transmit the video and audio packets for presentation based on the synchronization information; and
an intelligent stream management module operable to intelligently manage the system media stream to timely transmit the video and audio packets to said demultiplexor by:
receiving a first video packet of the system media stream;
determining whether a second video packet of the system media stream is received within a specified time after receiving the first video packet, the specified time corresponding to a predetermined rate for receiving video packets;
emulating the second video packet upon a determination that the second video packet was not received within the specified time, the emulated video packet comprising synchronization information for synchronizing the emulated video packet to the audio packet corresponding to the second video packet; and
transmitting the first video packet, the emulated video packet, and corresponding audio packets to said demultiplexor based on the synchronization information for the first video packet, the emulated video packet, and the corresponding audio packets.

43. The system according to claim 42, wherein the emulating step comprises duplicating the first packet.

44. The system according to claim 42, wherein the emulating step comprises estimating the second packet based on the first packet.

45. The system according to claim 42, wherein the specified time is about 39 msec.

46. A system for transmitting low bit rate multimedia content, comprising:
a video encoder operable to encode a video packet that represents video of the multimedia content, the video packet comprising synchronization information to synchronize the video packet with a corresponding audio packet;
an audio encoder operable to encode an audio packet that represents audio of the multimedia content, the audio packet comprising synchronization information to synchronize the audio packet with a corresponding video packet;
a multiplexor operable to generate a system media stream comprising the audio and video packets;
a supervisor module operable for determining a network communication rate indicating a bandwidth available for transmitting the system media stream, a media transmission rate indicating a bandwidth used to transmit the system media stream, and whether the media transmission rate is greater than the network communication rate; and
a compensation module operable for adjusting the media transmission rate upon on a determination that the media transmission rate is greater than the network communication rate.

47. The system according to claim 46, wherein said compensation module is operable for reducing a size of the audio and video packets in the system media stream to reduce the media transmission rate.

48. The system according to claim 46, wherein said compensation module is operable for smoothing video packets in the system media stream to reduce the media transmission rate to at least the network communication rate.

49. The system according to claim 48, wherein said compensation module is operable for smoothing video packets by:
determining a skipping rate necessary to render the media transmission rate less than the network communication rate; and
generating a revised system media stream by discarding video frames within the video packets at the determined skipping rate.

50. The system according to claim 46, further comprising a network header generation module operable for generating a network header comprising the media transmission rate for the system media stream,
wherein said supervisor module is operable for determining the media transmission rate by reading the network header.

51. The system according to claim 46, further comprising a demultiplexor operable to receive the system media stream and to transmit the video and audio packets for presentation based on the synchronization information.

52. The system according to claim 51, further comprising an intelligent stream management module operable to intelligently manage the system media stream to timely transmit the video and audio packets to said demultiplexor.
